(19) United States
(12) Patent Application Publication
(10) Pub. No.: US 2025/0356678 A1
(43) Pub. Date: Nov. 20, 2025

(54) Character recognition-based augmentation for multimodal model inputs

(71) Applicant: Google LLC, Mountain View, CA (US)

(72) Inventors: Yiming Gu, Glenshaw, PA (US); Ilaï Deutel, Pittsburgh, PA (US); Xi Chen, San Jose, CA (US); Chao Jia, Mountain View, CA (US); Xi Xiong, Santa Clara, CA (US); Joseph Pagadora, San Francisco, CA (US); Daniel Vlasic, Cambridge, MA (US)

(21) Appl. No.: 18/663,730

(22) Filed: May 14, 2024

(51) Int. Cl. G06V 30/19; G06V 30/24; G06V 30/30

(52) U.S. Cl. CPC G06V 30/19147; G06V 30/24; G06V 30/30

(57) ABSTRACT

Methods, systems, and apparatus, including computer-readable storage media for determining whether to add character recognition (CR) data to multimodal input and executing models with multimodal input augmented with the generated CR data, to improve the execution or accuracy of output generated by the models. CR data is information describing the presence or characteristics of text across input of different modalities, such as video, images, or audio. The system can include a multimodal model trained to receive the multimodal input and generate a corresponding output, in response to the input, and can be trained to determine whether to include the CR data in the multimodal input. The determination of whether to use multimodal input augmented with CR data can improve the accuracy of a model output, the computational efficiency in processing multimodal input, or both.

### BACKGROUND

A multimodal artificial intelligence (AI) model is a model that is capable of processing information from multiple modalities, such as images, videos, audio, and text, to generate output. A model often receives multimodal inputs raw or otherwise not processed or prepared in any way. For example, inputs to the model may be part of a prompt to a model from a user computing device that is not required or expected to pre-process a prompt to format or prepare the prompt for processing. Text recognition in multimodal information is an on-going problem for multimodal models. Errors in properly recognizing text from multimodal input can lead to inaccurate output or model hallucinations, especially when the input includes documents with images.

### BRIEF SUMMARY

Aspects of the disclosure are directed to determining whether to add character recognition (CR) data to multimodal input and executing models with multimodal input augmented with the generated CR data to improve the execution or accuracy of output generated by the models. CR data describes the presence or characteristics of text across inputs of different modalities, such as video, images, or audio. The system can include a multimodal model trained to receive the multimodal input and generate a corresponding output, in response to the input. The model can be trained to determine whether to include the CR data in the multimodal input. The determination of whether to use multimodal input augmented with CR data can improve the accuracy of a model output, or the computational efficiency in processing multimodal input.

### BRIEF DESCRIPTION OF THE DRAWINGS

FIG. 1 is a block diagram of a multimodal processing system configured to generate CR data and determine whether to use the CR data with multimodal input as input to a multimodal model, according to aspects of the disclosure.

FIG. 2 is a block diagram of a multimodal processing system configured to determine whether to generate CR data-augmented input for the multimodal model, according to aspects of the disclosure.

FIG. 3 is a block diagram of a multimodal processing system including a multimodal model trained to determine whether to generate output with or without multimodal input augmented with CR data, according to aspects of the disclosure.

FIG. 4 is a flow diagram of an example process for generating CR data and determining whether to use the CR data with multimodal input to a multimodal model, according to aspects of the disclosure.

FIG. 5 is a flow diagram of an example process for training a model to determine whether to generate output with or without multimodal input with CR data, according to aspects of the disclosure.

FIG. 6 is a block diagram illustrating one or more multimodal models, such as for deployment in a datacenter housing a hardware accelerator on which the deployed models will execute for multimodal processing with CR data, according to aspects of the disclosure.

FIG. 7 is a block diagram of an example computing environment for implementing a multimodal processing system.

### DETAILED DESCRIPTION

### Overview

Aspects of the disclosure relate to determining whether to add character recognition (CR) data to multimodal input and executing models with multimodal input augmented with the generated CR data, to improve the execution or accuracy of output generated by the models. CR data describes the presence or characteristics of text across inputs of different modalities, such as video, images, or audio. In addition to text identified in multimodal input, CR data may include bounding boxes, coordinate data, and other information to identify the location of text identified within images, video, or audio. Optical character recognition (OCR) is a technology that can be used to generate character recognition data for identifying or at least partially characterizing text in multimodal input. For audio, speech-to-text techniques or other approaches may be used to identify the location of text as a timestamp during which some speech or sound represented by the text occurred.

A multimodal model is a model, such as a machine learning model trained such that, when executed by a computing device or processor, the model causes the computing device or processor to perform some tasks on input that includes data of multiple modalities. Example tasks include image attribution or categorization, information extraction, responding to information-seeking questions relying on texts in images, document parsing, infographic or visual aid question answering, etc.

Some models, including general-purpose multimodal models, are trained to receive multimodal input of various formats, lengths or sizes, content types, etc., allowing the models to handle a variety of tasks. The accuracy or associated cost of pre-processing input such as video or images for character recognition varies from input-to-input. A system can determine that processing input without performing character recognition on non-text modalities in the input can be performed without substantially affecting the accuracy of the resulting model output. In some examples, if character recognition can be avoided, the system can execute a multimodal model more efficiently, at least because pre-processing the multimodal input to identify text in video or images may be avoided. The multimodal model may be trained to recognize text in multimodal input without the need to pre-process for character recognition, meaning that character recognition before processing input through the model is not always necessary.

A user computing device can interact with a multimodal model through a multimodal agent, such as a chat agent. The multimodal agent can be, for example, an instance of a multimodal model trained to receive the multimodal input and generate a corresponding output, in response to the input. In addition to communicating with or implementing the multimodal model, the multimodal agent may implement a user interface for communicating with a user computing device, or track additional data, such as a history of input and output received and provided to the user computing device. In some examples, a multimodal agent receives multimodal input and automatically provides the input to a CR engine configured to augment the input with CR data. For example, the CR data can include tag data or metadata. In some examples in which the input includes images or video, the CR data can include a transcript of text identified in the images or video, or bounding boxes or other indicators to identify recognized text in the input.

The agent can apply one or more criteria or filters to determine whether to proceed with the CR data-augmented multimodal input or provide only the multimodal input to a multimodal model. Example criteria can include whether: the CR data was received later than a predetermined latency period; the multimodal input includes too many images; the confidence rating of the CR engine in correctly identifying text in the input is below a predetermined threshold; the quality or size of components of the multimodal input does not meet predetermined thresholds; the CR data includes too few symbols, words, lines, or paragraphs for the model to perform the task it was trained to perform, or the input is too large for the model to accept.

Example filters can include automatic pre-processing operations performed on the multimodal input. For example, the multimodal input may be pre-processed to be truncated to a size accepted by the CR engine or the multimodal model. As another example, the multimodal input may have images that are too small or lack enough resolution for the CR engine filtered out, so that the input to the CR engine contains only input from which CR data can be generated.

In some examples, the multimodal agent can make a determination whether to send the multimodal input to the CR engine. In this regard, the multimodal agent can apply one or more criteria or filters to the multimodal input itself. These criteria or filters may be based on, for example: the length of the multimodal input, the quantity of images or videos in the multimodal input, or the resolution or quality of components of the multimodal input. Based on whether the multimodal input satisfies or does not satisfy the criteria, the multimodal agent may or may not send the multimodal data to the CR engine.

The multimodal model can be trained to provide output that may or may not rely on CR data, in addition to multimodal input. For example, a processor device implementing the multimodal model may perform multiple passes of the model. A first pass of the model can be performed using just the multimodal input, while a second pass of the model can be performed with the multimodal input augmented with the CR data. The multimodal model can compare the results of the output from both passes, and select the output predicted to be more accurate or more responsive to the input. For example, when the output without the CR data does not satisfy confidence or quality scores computed by the multimodal model, the model can select the output generated with the CR data-augmented input. To that end, the agent can use the CR engine as a tool to augment the final output of the model, without the CR engine being required to be executed for each model input if the quality or confidence of the model output without CR data meets predetermined thresholds.

The multimodal model can be trained according to a supervised learning approach, for example, in which training data to the model includes pairs of input with and without CR data, and a corresponding label. The label can be, for example, a ground-truth label with which pairs of corresponding outputs may be compared. As another example, the label may indicate which input in a pair produces the more accurate output.

A multimodal processing system implementing the technology may implement any or all the examples of determination logic described herein. The different examples may be categorized into different modes, which may be toggled automatically or by user input. For example, a rule-based mode may be selected, in which the multimodal agent, the CR engine, or another component in communication with the platform determines whether to use generated CR data as part of the multimodal input to a multimodal model, based on whether the multimodal input satisfies certain criteria or filters. The determination described here can be made by a multimodal processing system on a component-by-component basis of the multimodal input, where each component can be, for example, a picture, a video clip, an audio clip, etc.

As another example, a multimodal agent mode may be selected, in which the multimodal agent or multimodal model determines whether to generate or use the results of output generated using CR data-augmented input. For example, the agent may determine whether to generate CR data at all. As another example, the multimodal model may perform multiple passes with and without CR data-augmented input, to determine which output to provide in response to the multimodal input.

The CR engine may be configured to generate CR data according to various CR formatting options, e.g., text words, lines, with bounding boxes, etc., to match the appropriate form of text recognition for different types of multimodal input. The CR engine can process and recognize text according to different combinations of modalities in input, such as different combinations of images, text, video, audio, etc. This flexibility enables the CR engine to be implemented in conjunction with a variety of different models with different input formats or parameters. In some examples, the multimodal model can be fine-tuned with examples formatted in accordance with these different formatting options, which can result in more accurate parsing and processing of the multimodal inputs by the model.

The CR engine may determine which formats to use based on different criteria or conditions. For example, if the multimodal input meets or exceeds a predetermined maximum input size, the CR engine may select one format over another. The CR engine may use other formats with more or less CR data, for example in response to user input, or automatically. In some examples, if the resulting CR data and multimodal input become too large to provide as input to the multimodal model, then the multimodal agent, the CR engine, or some other component in communication with the system may divide or partition the input and CR data. The size of these sub-inputs may vary, for example based on the maximum context window size of the multimodal model.

The technology can provide at least the following technical advantages. The determination of whether to use multimodal input augmented with CR data can improve one or both of the accuracy of a model output, the computational efficiency in processing multimodal input. Multimodal models may be implemented over approaches in which separate models are trained for each modality, e.g., a model for video input, a model for image input, etc. A multimodal model can be more efficient than the separate model approach, however the multimodal model can require additional pre-processing because the range of possible inputs is wider. Aspects of the disclosure implemented with a multimodal model enables the multimodal approach, while improving the efficiency of pre-processing input for character recognition.

A generative model may be able to identify characters or words from text, but its recognition ability is a product of its internal processing and is often limited, for example because of the resolution/token limit on the model may not be able to perform the character recognition accurately in all cases. However, running character recognition in all inputs is costly and is not always beneficial, e.g., in the form of improved accuracy.

Instead, an agent determining whether to invoke a CR engine and pre-process multimodal input with CR data can improve computational efficiency by only invoking the CR engine when the accuracy of the resulting model output may improve over processing the multimodal input alone. If the model output does not improve, or improves marginally or with low probability, the system can save on the computational resources, such as the processing cycles to generate the CR data, or the bandwidth to communicate the multimodal input to and from the agent and the model.

### Example Systems

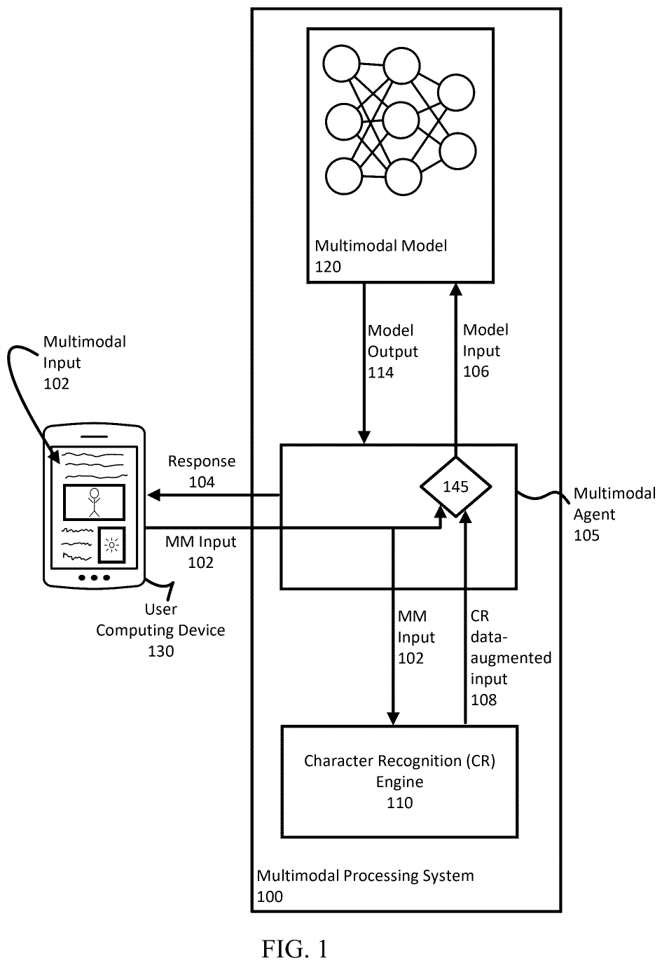

FIG. 1 is a block diagram of a multimodal processing system 100 configured to generate CR data and determine whether to use the CR data with multimodal input as input to a multimodal model 120, according to aspects of the disclosure. The multimodal input 102 and the responses 104 can be any combination of text, audio, video, images, etc. The system 100 can include a multimodal agent 105, a character recognition (CR) engine 110, and the multimodal model 120.

The multimodal agent 105 can be configured to receive multimodal input 102 from a user computing device 130 and provide responses 104 to the received input. The multimodal agent 105 may be implemented in either software or hardware, for example as a web application accessible by the user computing device 130 over a web browser, as an application or system configured to receive remote procedure calls, a program implementing an application programming interface (API), etc. Although shown as part of the system 100, the agent 105 can, in some examples, be implemented on the user computing device 130, for example as a mobile application, part of an operating system for the device 130, a desktop application, etc.

The multimodal agent 105 can function as a chat or voice assistant and provide a natural language interface for communicating input 102 and response 104 to and from the system 100 and the user computing device 130. For example, the multimodal agent can be implemented as a chat agent, receiving multimodal input 102 as text, videos, audio, etc. The multimodal input 102 may be received directly, for example through a user interface, such as a graphical input prompt. The multimodal input 102 may be received indirectly, for example through a command to retrieve input from another source or device different than the user computing device 130.

The multimodal agent 105 may also be configured with additional features and functionalities to facilitate user interaction, accurate querying of the multimodal model 120, and so on. For example, the multimodal agent 105 can have access to memory for storing previous inputs from the user computing device 130 or other devices interacting with the agent 105 or other agents implemented by the system 100. Previous inputs may be used as additional model input 106, in combination with the multimodal input 102 received by the agent 105.

The multimodal agent 105 can be an intermediary between the user computing device 130 and the multimodal model 120. The agent 105 receives multimodal input 102 and generates corresponding model input 106. The agent 105 may format or process the multimodal input 102 or CR data-augmented input 108 to generate the model input 106 in a format or manner that the multimodal model 120 is trained to receive. The agent 105 implements determination logic 145 for determining whether to generate the model input 106 from either the multimodal input 102, or the CR data-augmented input 108.

Character recognition (CR) engine 110 is configured to receive the multimodal input 102 from the agent 105 and generate CR data. CR data can be information describing the location or characteristics of text in the multimodal input 102. The CR engine 110 can generate the CR according to different formats, e.g., text words, lines, with bounding boxes, etc., to match the appropriate form of text recognition for different types of multimodal input. The CR engine 110 can use various techniques for recognizing text in non-text modalities, including optical character recognition (OCR) or speech-to-text on audio components of multimodal input.

The CR engine 110 can process and recognize text according to different combinations of modalities in input, such as different combinations of images, text, video, audio, etc. The CR engine 110 can process the input component-by-component, for example when the input 102 includes different components including text, images, videos, etc. This flexibility enables the CR engine 110 to be implemented in conjunction with various multimodal models with different input formats or parameters. In some examples, the multimodal model 120 can be fine-tuned with examples formatted in accordance with these different formatting options, which can result in more accurate parsing and processing of the multimodal inputs by the model.

In some examples, the CR engine 110 is configured to generate data recognizing text at different levels of granularity, e.g., at the individual character level or at the word or token level. In some examples, the multimodal input 102 includes audio information, such as audio clips, audio accompanying videos, etc. The CR engine 110 can be configured to generate transcripts of the audio. In some examples, the CR engine 110 can process the audio input through a speech to text sub-engine or model, to determine the meaning and content of the audio. The CR engine 110 can generate a transcript of the audio input as part of the CR data.

In some examples, the CR engine 110 can be configured to provide a confidence value or rating as part of its output to the agent 105. The confidence rating can be a heuristic or estimation of the likelihood that the CR data output by the engine 110 is accurate. The confidence rating can be generated as part of processing input through the CR engine 110, e.g., for each character or word identified, the CR engine 110 can assign a confidence score measuring the probability that the character or word was correctly identified.

The CR engine 110 may determine which of various formats to use, based on different criteria or conditions. For example, if the multimodal input meets or exceeds a predetermined size, the CR engine may select one format over another. The CR engine may use other formats with more or less metadata characterizing identified text in the multimodal input, for example in response to user input or automatically. In some examples, if the resulting CR data and multimodal input become too large to provide as input to the multimodal model, then the multimodal agent 105, the CR engine 110, or some other component in communication with the system 100 may divide or partition the multimodal input 102 or the CR data. The size of these sub-inputs may vary, for example based on the maximum context window size of the multimodal model 120.

The following example formats and others may be combined or used interchangeably. One example format in which the CR engine 110 can generate the CR data-augmented input 108 is as shown in TABLE 1, below:

TABLE 1

| | |
|---|---|
| 1 | <image> |
| 2 | The text recognized in the image is: |
| 3 | --- CR Data Start --- |
| 4 | {CR Data} |
| 5 | --- CR Data End --- |
| 6 | <text_prompt> |

<image> in line 1 is a placeholder for an image that may be found in the multimodal input 102. For each image, audio clip, video, etc., the CR data-augmented input 108 can include a respective section with CR data, for example as shown in lines 2 through 5 of TABLE 1. {CR Data} is a placeholder for CR data generated by the CR engine 110, using the <image> as input in this example.

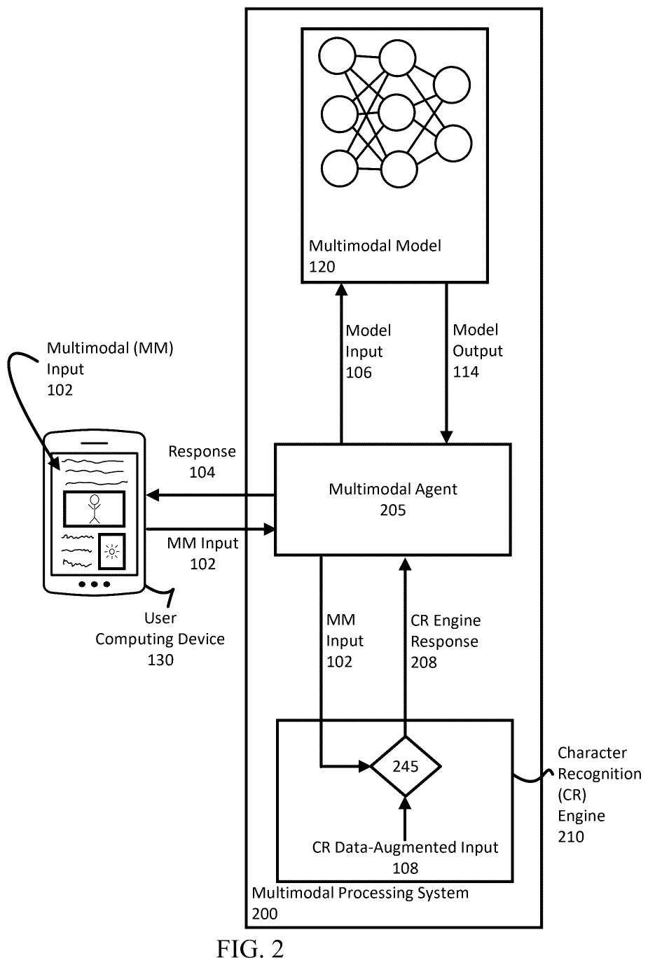

After each non-text portion of the multimodal input 102 is processed, the CR data-augmented input 108 can include a text prompt, for example found in the input 102 and as shown by the placeholder <text_prompt> in line 6 of TABLE 1. As described in more detail with reference to FIG. 2, in some examples the CR engine 110 can implement determination logic 245 to determine whether to output the multimodal input 102 or the CR data-augmented input 108, based on characteristics of the CR data, such as the length of the CR data relative to the multimodal input 102.

In some examples, the CR engine 110 may add additional instructions as part of the multimodal input 102. The additional instructions may be added to improve the likelihood that the model 120 outputs an accurate output in response to the input 102. For example, an additional instruction may be added to the input CR data-augmented input 108, stating “Based on the image(s) above and the knowledge of the world, please provide a response to the following prompt: <text_prompt>.”

As another example, the additional instructions may include clarification or detail to the characters or text recognized in the multimodal input 102. For example, the CR engine 110 can include a description of the location of the CR data in the input 102. TABLE 2 shows an example of CR data-augmented input 108 with location descriptions in the multimodal input 102:

TABLE 2

| | |
|---|---|
| 1 | <image> |
| 2 | The CR lines of <image> are in the following format: |
| | {content}, {location}. {location} refers to relative |
| | coordinates of a bounding box for the content, in the format |
| | of xmin, ymin, xmax, ymax, scaled to [0, 1000]. |
| 3 | --- CR Data Start --- |
| 4 | {Content line}, {Content Line Coordinate} |
| 5 | --- CR Data End --- |
| 6 | <text_prompt> |

Line 1 shows a placeholder for an example <image>, as in TABLE 1. Additional instructions are added in line 2, which specify how the CR data is formatted. In this example, individual lines of text are bounded by a respective bounding box, whose coordinates are provided as a tuple corresponding to the starting point in the x-dimension (xmin), starting point in the y-dimension (ymin), ending point in the x-dimension (xmax), and ending point in the y-dimension (ymax). The CR data as shown in line 4 follows the format described in line 2. In some examples, the additional instructions to the multimodal model can explicitly state that the coordinates should not be referenced or mentioned in the resulting model output. In some examples, the additional instructions may include instructions to only the coordinates in a model output, if deemed necessary or appropriate for responding to the model input 102.

As another example, the additional instructions can specify that the CR data is organized as a group of tagged lines, e.g., a first line tagged as <0>, a second line tagged as <1>, and so on. For example, the additional instructions may state: “The OCR lines of image are as follows, in a format of the OCR line content, followed by an ordered line tag such as <0>, <1>, <2>, . . . , and do not include the line tags in the output.”

Determination logic 145 can encode or represent one or more criteria or filters the agent 105 is configured to apply in determining whether to provide the multimodal input 102 or the CR data-augmented input 108 to the multimodal model 120. Although shown as receiving the CR data-augmented input 108 in FIG. 1, in some examples the agent 105 may determine not to send the multimodal input 102 at all, bypassing the engine 110 and sending the input directly to the model 120. In different examples, the determination logic 145 can be a series of weighted factors weighing against or for the determination to send multimodal input 102 to the CR engine 110. In some examples, the criteria or filters of the determination logic 145 are implemented as a hierarchy, with the satisfaction of some criteria outweighing other criteria. The logic 145 can be implemented, for example, in a combination of software and hardware, including a computer program or appropriately configured circuit, which a component such as the multimodal agent 105 or the CR engine 110 is configured to execute.

The agent 105 may track the latency in response from sending the multimodal input 102 to the CR engine 110 and receiving the CR data-augmented input 108 in response. If the time exceeds a predetermined latency period, the agent 105 can default to sending the multimodal input 102 to the model 120. The predetermined latency period may be selected, for example, based on a service level agreement or other guarantee of agent responsiveness to the user computing device 130. In some examples, the predetermined threshold may be empirically determined, for example as a trade-off between model accuracy or responsiveness relative to response time. An example predetermined latency period is 1000 ms, although the period can vary from example-to-example, e.g., 500 ms, 1500 ms, etc.

In some examples, the agent 105 determines whether the number of non-text components in the multimodal input 102 is above or below predetermined quantity thresholds. For example, agent 105 may automatically send multimodal input 102 to the model 120, if the multimodal input 102 includes too many images for the CR engine 110 to process. The quantity threshold of images may be selected based on, for example, the likelihood that the CR engine 110 is capable of processing the images in the input 102 within an acceptable latency period. As a result, the quantity threshold may change depending on the computing resources, e.g., memory, bandwidth, processing cycles, available to the CR engine 110. The agent 105 may apply a similar approach to images that are below a predetermined size threshold, because the CR engine 110 may require a certain size or image resolution for performing character recognition.

Quantity thresholds can be based on parameters or characteristics of the generative model 120. For example, the model 120 can have a token limit, e.g., thousands, tens-of-thousands, or more tokens that can be processed by the model 120 at a time. Tokens representing images or parts of images, e.g., image patches, can take up some or all of the model token limit. If the overall token limit is exceeded when the CR data is added to the input, then the agent 105 can default to the multimodal input 102, under the token limit.

In some examples, the CR engine 110 may track a confidence rating for its output. The agent 105 may receive the confidence rating and only provide the CR data-augmented input 108 as input to the model 120, if the confidence rating is above a certain threshold, e.g., 95% accuracy.

In some examples, the agent 105 may reject or modify the CR data-augmented input 108 if the input is too large for the model 120. For example, the agent 105 may default to the multimodal input 102 if the CR data-augmented input 108 is too large. In some examples, the agent 105 can truncate or otherwise cause the CR data-augmented input 108 to shrink to a size accepted by the model 120 as input. The model 120 may have a predetermined maximum input or context window, in which a limited input size or number of tokens are accepted as input. In some examples, the agent 105 may divide model input into a sequence of sub-divided inputs, each sub-divided input within the context window size of the model 120.

The agent 105 can determine whether to generate model input 106 using the CR data-augmented input 108 to the agent 205, based on the length or quality of the CR data generated. For example, if the length of the CR data generated does not meet a predetermined length, e.g., fifteen or twenty words, then the agent defaults to the multimodal input 102 instead of the CR data-augmented input 108.

The agent 105 can apply filters to the multimodal input 102. For example, the agent 105 can perform pre-processing operations for truncating or removing data, such as when the multimodal input 102 is too large or contains images that are too small or lack enough resolution for the CR engine 110 to process. These filters can be applied in addition or as an alternative to the criteria described herein for rejecting CR data based on multimodal input that does not satisfy predetermined size or quality requirements.

The predetermined length may be determined based on, for example, comparing results of the model 120 with and without CR data of the predetermined length. If the results are not improved, or if they are improved less than a predetermined threshold, then the length of the CR data associated with the observed results may be used as the predetermined length. One reason to exclude the CR data is because the brevity or lack of words identified in the multimodal input 102 is unlikely to improve the output of the model 120. Other predetermined thresholds may be obtained in a similar fashion and used by the CR engine 210 to determine whether to output CR data-augmented input 108.

Whether the agent 105 generates the model input 106 from the multimodal input 102 or the CR data-augmented input 108, the multimodal model 120 is trained to process the input 106 and generate a model output 114. The agent 105 can process the model output 114 to generate the response 104. For example, the response 104 may be a human-readable response, or the response 104 may be a formatted version of the model output 114 suitable for output by the agent 105 according to one or more predetermined requirements or criteria. This input-output loop can continue with new multimodal inputs received by the agent 105, and responses to those new inputs sent to the user computing device 130.

The inputs and outputs can correspond to any task that the multimodal model 120 is trained to perform. Example tasks include image attribution or categorization, information extraction, responding to information-seeking questions relying on texts in images, document parsing, infographic or visual aid question answering, etc. Other example tasks are provided herein, as well as example configurations and computing environments for implementing the multimodal processing systems and the user computing device. For example, the multimodal model 120 can be one or more large generative models, such as a large language model, a large foundation model, a large graphical model, etc.

FIG. 2 is a block diagram of a multimodal processing system 200 configured to determine whether to generate CR data-augmented input for the multimodal model, according to aspects of the disclosure. The components of the system 200 can include a multimodal model, for example the multimodal model 120 as described with reference to FIG. 1. Multimodal agent 205 may be configured as the multimodal agent 105, except without determination logic 145. Instead, CR engine 210 can be configured like CR engine 110, but with determination logic 245. The CR engine 210 can execute the determination logic 245 to determine whether CR engine response 208 includes just the multimodal input 102 or the CR data-augmented input 108 generated by the CR engine 210.

Implementing the determination logic 245 on the CR engine 210 can result in more efficient processing, at least through fewer processing cycles or other computing resources used to generate CR data that may be rejected, such as by the agent 105 implementing determination logic 145. In different examples, where the determination logic is implemented can vary, for example based on the likelihood of the CR data being generated within accuracy and latency thresholds. For instance, if the CR engine is implemented on hardware that reliably generates CR data within accuracy and latency thresholds, the determination logic may be implemented on the agent 105, which has the benefit of being able to directly compare the multimodal input 102 and the CR data-augmented input 108 for determining which should form part of the model input 106. In other examples, the CR engine 210 may implement the determination logic 245, which results in fewer wasted processing cycles or other computing resources caused when CR data is generated that is later rejected by the agent 105.

A multimodal processing system may include agents and CR engines that are both configured for applying the determination logic described herein. The option to choose which component performs the determination allows a system to be easily adapted to different types of multimodal workloads, where one approach may be more efficient in terms of computing resource usage over another. The determination of which approach to use for a given workload may be predetermined, or the system may be configured to select a mode of approach based on historical data, empirical testing, and so on.

The determination logic 245 may include criteria, thresholds, or filters as described with reference to the determination logic 145 implemented by the agent 105. Instead of determining whether to use the CR data-augmented input or not, the CR engine 210 determines whether to generate or provide CR data to the agent 205 at all. For example, the engine 210 can determine whether the multimodal input 102 contains too many images, images that are too small, etc., as part of generally determining whether the CR engine 210 can accurately generate CR data within an acceptable latency threshold. As another example, the engine 210 may generate CR data, but determine not to provide the CR data-augmented input 108 to the agent 205 based on a confidence rating for the CR data falling below a predetermined quality threshold.

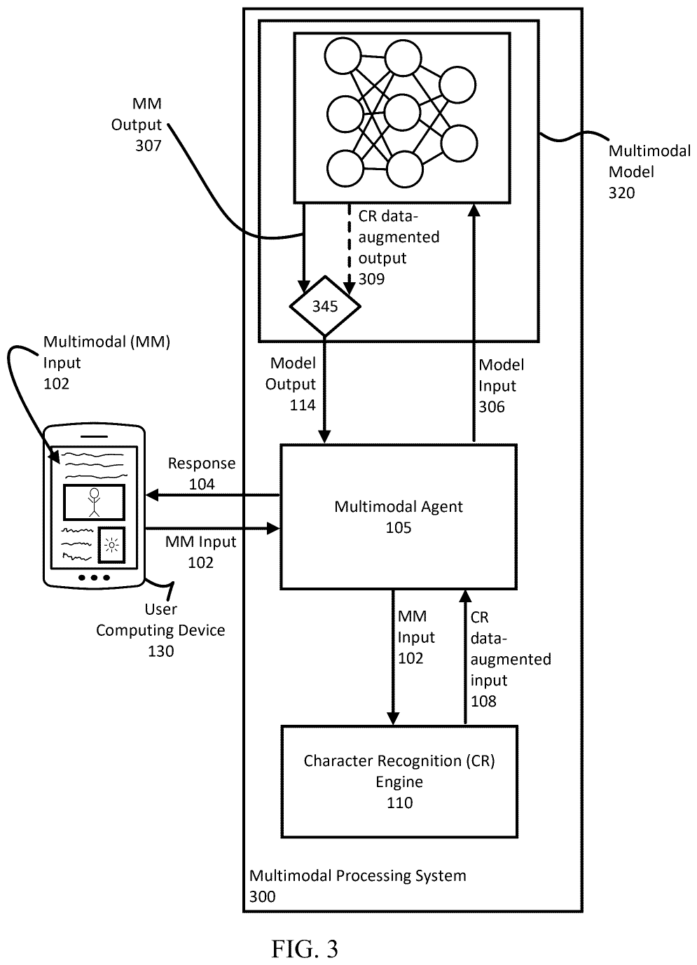

FIG. 3 is a block diagram of a multimodal processing system 300 including a multimodal model 320 trained to determine whether to generate output with or without multimodal input augmented with CR data, according to aspects of the disclosure. The components of the system 300 can include a multimodal agent, such as multimodal agent 105 or multimodal agent 205, for example as described or shown with reference to FIGS. 1 and 2, respectively. Similarly, the system can include a CR engine, such as CR engine 110 or CR engine 210, for example, as described with reference to FIGS. 1 and 2, respectively.

Model input 306 includes both the multimodal input 102, as well as the CR data-augmented input 108. In some examples, instead of sending separate components of the model input 306, the multimodal agent 105 can send the CR data-augmented input 108 only, and the model 320 or another component of the system 300 can be configured to extract the input 102 from the augmented input 108.

In some examples and as shown in the system 300, the model 320 is trained to determine whether model output 114 should include multimodal output 307—generated using only the multimodal input—or CR data-augmented output 309—generated using the CR data-augmented input 108 generated by the CR engine 110. In some cases, model accuracy may be impacted positively or negatively by CR data, depending on, for example, the quality of the CR data or the benefit to the model accuracy or performance, in the form of additional input data.

In some examples, the multimodal model 320 may perform multiple passes. A first pass of the model 320 can be performed using just the multimodal input 102, while a second pass of the model can be performed with the CR data-augmented input 108. The multimodal model 320 can compare the results of the output from both passes, and select the output predicted to be more accurate or responsive to the input. For example, the multimodal model 320 may be trained to generate confidence or quality scores measuring the confidence that a given output is accurate, or the quality of the output, for example as a measure of responsiveness to a given prompt. In some examples, a general-purpose generative model can be used, e.g., a generative model trained on a training set of multimodal data, but which was not additionally trained for determining whether to use output generated using CR data. To that end, the multimodal model 320 can leverage CR data-augmented input, for example in cases in which the model 320 is processing input for which it generates lower confidence or quality scores, without the augmented input. However, CR recognition is not built into the preprocessing pipeline as a requirement, allowing the model to generate output with CR data if its quality or confidence scores are sufficient, e.g., meeting predetermined confidence or quality thresholds.

The machine learning models can be trained according to a variety of different learning techniques. Learning techniques for training the machine learning models can include supervised learning, unsupervised learning, semi-supervised learning, and reinforcement learning techniques.

For example, the multimodal model 320 can be trained or fine-tuned according to a supervised learning approach, for example, in which training data to the model includes pairs of input with and without CR data, and a corresponding label. The label can be, for example, a ground-truth label with which pairs of corresponding outputs may be compared. As another example, the label may indicate which input in a pair produces the more accurate output. The label and the model output can be evaluated through a loss function to determine an error, which can be backpropagated through the model to update weights for the model. In examples in which the multimodal model 320 is fine-tuned, the multimodal model 320 can be based off of a generative model trained on a corpus of data that may or may not include multiple modalities. Any of a variety of loss or error functions appropriate for measuring the loss between the outputs can be used, such as mean square error. The multimodal model 320 can be trained by a model training engine (not shown) until stopping criteria are met, such as a number of iterations for training, a maximum period of time, a convergence, or when a minimum accuracy threshold is met.

### Example Methods

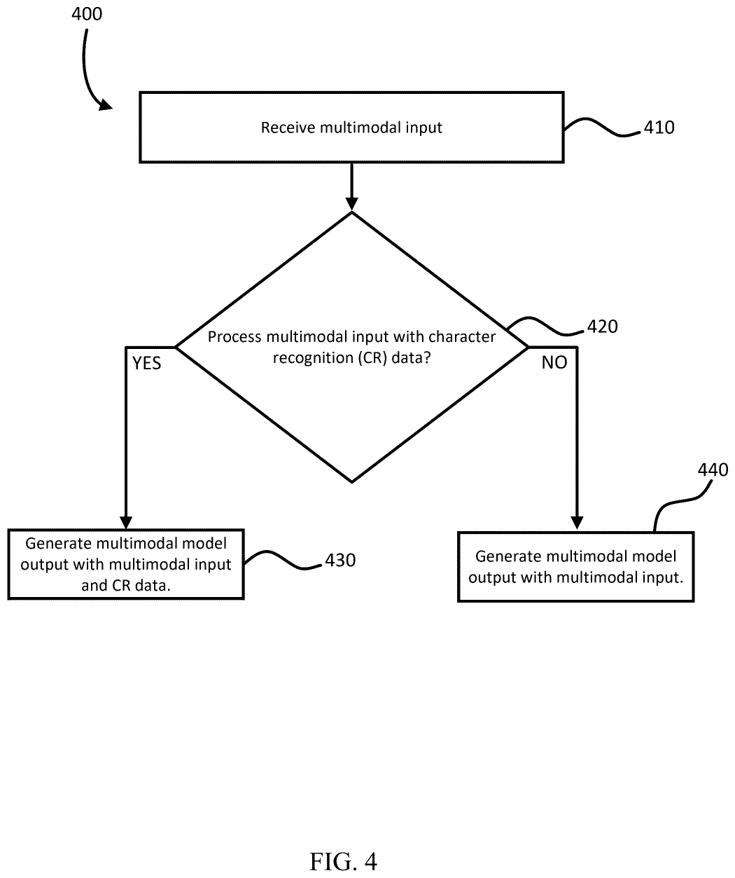

FIG. 4 is a flow diagram of an example process for generating CR data and determining whether to use the CR data with multimodal input to a multimodal model, according to aspects of the disclosure. The example process can be performed on a system of one or more processors in one or more locations, such as the multimodal processing system 100 of FIG. 1 or the system 200 of FIG. 2.

The system receives multimodal input including at least two of text, images, video, or audio, according to block 410. The multimodal input can be received, for example, through a user computing device in communication with the system. The system may be configured to perform a variety of different tasks on multimodal input and using the multimodal model. Example tasks include image attribution or categorization, information extraction, responding to information-seeking questions relying on texts in images, document parsing, infographic or visual aid question answering, etc.

The system determines whether to process the multimodal input with character recognition (CR) data through a multimodal model trained to receive the multimodal input and generate a model output, according to block 420. The multimodal input with CR data can be, for example, the CR data-augmented input 108 as shown and described with reference to FIGS. 1-3. CR data is data that identifies or characterizes text in the multimodal input. A variety of techniques can be used to generate the CR data, including optical character recognition (OCR) and speech-to-text techniques in examples in which the multimodal input includes audio.

As part of determining whether to process the multimodal input with the CR data, the system can generate the CR data. For example, the CR engine of the system may automatically generate CR data from an input. The system can determine, for example through determination logic implemented on a multimodal agent, whether the CR data meets one or more predetermined criteria. The predetermined criteria can include, for example, whether: the CR data was received too late, the input augmented with the CR data includes too many images the confidence rating of the CR engine in correctly identifying text in the input is below a predetermined threshold, the quality or size of components of the response does not meet predetermined thresholds.

In some examples, the CR data or the multimodal input can be filtered to cause the data or input to be acceptable for input at the CR engine. For example, the system can determine that the CR data-augmented input exceeds the predetermined maximum input size for the multimodal model. In response to the determination, the system can divide the multimodal input or the CR data into a plurality of inputs that are each no larger than the predetermined maximum input size. The predetermined maximum input size can be based on the maximum context window length of the multimodal model.

In some examples, the system can first determine whether to generate the CR data at all. For example, the CR engine can be configured to process the multimodal input through one or more criteria or filters, to make the determination to generate CR data. The criteria can be based on, for example, the length of the multimodal input, the quantity of images or videos in the multimodal input, the size of the images or video in the multimodal input, or the resolution or quality of components of the multimodal input.

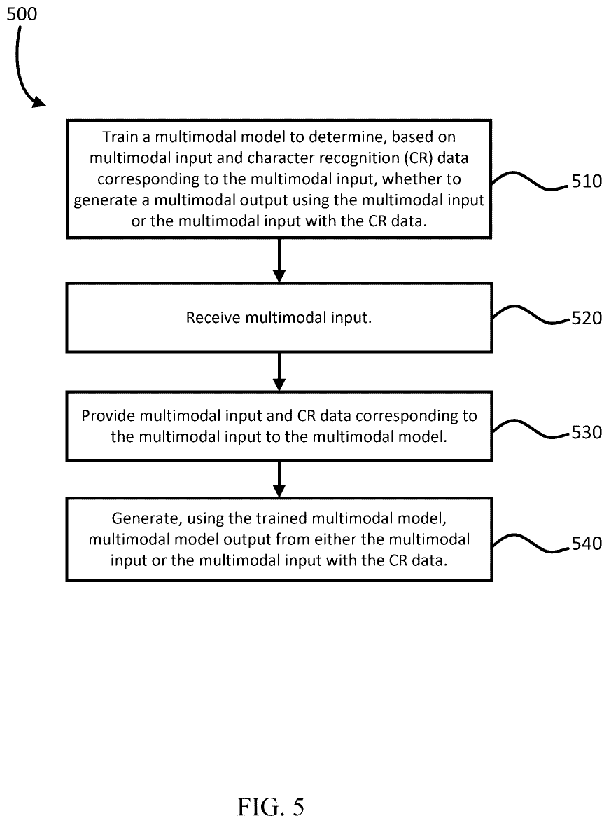

In some examples, the multimodal model is configured to make the determination whether to use the multimodal input alone or with the CR data to generate a model output. The model may be configured to compare the results of two passes in generating output, one with only the multimodal input and one with both the multimodal input and CR data and compare the results to select a higher-performing option. In some examples, the multimodal model is trained or fine-tuned from an existing model to determine whether to use the CR data as part of the multimodal input or not. In some examples, the model is pre-trained to determine which result results in higher performance, e.g., higher accuracy. FIG. 5 illustrates an example process for training the multimodal model.

If the system determines to process the multimodal input with the CR data through the multimodal model (“YES”), then the system generates the multimodal model output using the multimodal input with CR data, according to block 430.

The system can include a multimodal agent, e.g., a chat agent, configured to receive multimodal input and CR data and pass data as input to the multimodal model. The agent can receive a model output and in turn provide a response to the source of the multimodal input, such as a user computing device. The system can generate the CR data-augmented input according to a variety of predetermined formats. The system can select a format based on, for example, the length or size of the CR data or the multimodal input.

If the system determines not to process the multimodal input with the CR data through the multimodal model (“NO”), then the system generates the multimodal model output using only the multimodal input, according to block 440.

FIG. 5 is a flow diagram of an example process 500 for training a model to determine whether to generate output with or without multimodal input with CR data, according to aspects of the disclosure. The example process can be performed on a system of one or more processors in one or more locations, such as the multimodal processing system 300 of FIG. 1.

The system trains a multimodal model to determine, based on multimodal input and character recognition (CR) data corresponding to the multimodal input, whether to generate a multimodal output using the multimodal input or the multimodal input with the CR data, according to block 510.

As described herein, for example with reference to FIG. 3, the system can be trained in accordance with different training methods. For example, training data for training the multimodal model can include examples of model outputs generated with multimodal inputs, and examples of model outputs generated with the multimodal inputs and respective CR data identifying or characterizing text in each of the multimodal inputs. The training examples are labeled with a respective measure of accuracy, indicating which variant of processing the multimodal input (with or without CR data) led to higher accuracy overall. The training process can be performed by a model training engine, which may be part of the system or part of one or more devices physically or logically separate from the system.

In some examples, instead of training the multimodal model, an existing multimodal model can be fine-tuned to perform a determination as to whether to select multimodal model output based on multimodal input that may or may not be augmented with CR data as described herein. The data set for fine-tuning the multimodal model may be smaller than the data set for training the model.

The system receives multimodal input, according to block 520. The multimodal input can include at least two components of text, images, video, or audio.

The system provides the multimodal input and CR data corresponding to the multimodal input to the multimodal model, according to block 530. The system generates, using the trained multimodal model, multimodal model output from either the multimodal input or the multimodal input with the CR data, according to block 540.

As part of generating the multimodal model output, the system can process input through two passes of the multimodal model. In a first pass, the multimodal input alone is processed through the model to generate a first output. In a second pass, the multimodal input augmented with CR data is processed through the model to generate the second output. The first and the second output are compared to select one of the two as the multimodal output.

In some examples, a separate model is trained or fine-tuned from the multimodal model and receives both the first and second outputs of the first and second pass, respectively. This separate model and the multimodal model may then be processed or trained end-to-end, to create a pipeline that generates an output based on a determination of whether or not to use the CR data along with the multimodal input.

Implementations of the present technology include, but are not limited to, the following:
(1) A method, including: receiving, by one or more processors, multimodal input including at least two of text, images, video, or audio; determining, by the one or more processors and based on one or more criteria, whether to process the multimodal input with character recognition (CR) data through a multimodal model trained to receive the multimodal input and generate a multimodal model output; and in response to determining to process the multimodal input with the CR data based on the one or more criteria, generating, by the one or more processors, the multimodal model output using the multimodal input and the CR data.
(2) The method of (1), wherein the CR data identifies or characterizes text in the multimodal input.
(3) The method of either (1) or (2), wherein determining whether to process the multimodal input with the CR data includes: generating the CR data; and determining whether the generated CR data meet the one or more predetermined criteria, and in response, generating, by the one or more processors, the multimodal model output using the multimodal input without the CR data.
(4) The method of any one of (1) through (3), wherein determining whether to process the multimodal input with CR data includes determining whether the multimodal input or the CR data satisfy the one or more predetermined criteria, including one or more of whether: the CR data was received past a predetermined latency period, the multimodal input or the CR data includes a quantity of images in excess of a predetermined limit, a confidence rating in generating the CR data is below a predetermined threshold, the quality of components of the multimodal input or the CR data does not meet a predetermined threshold, the size of images or video of the multimodal input exceeds a predetermined maximum size, the multimodal input with the CR data includes a quantity of symbols, words, lines, or paragraphs below a predetermined threshold determined for the multimodal model to perform a task it was trained to perform, or the multimodal input and the CR data exceeds a predetermined maximum input size.
(5) The method of any one of (1) through (4), wherein determining whether to process the multimodal input with the CR data includes: determining, based on the multimodal input and the one or more criteria, whether to generate the CR data from the multimodal input; and in response to determining to generate the CR data, generating the CR data from the multimodal input.
(6) The method of (5), wherein the one or more criteria are based on at least one of: the length of the multimodal input, the quantity of images or videos in the multimodal input, the size of the images or video in the multimodal input, or the resolution or quality of components of the multimodal input.
(7) The method of any one of (1) through (6), wherein the method further includes: generating, by the one or more processors, the CR data; and formatting, by the one or more processors, the multimodal input and the CR data according to one of one or more predetermined formats.
(8) The method of any one of (1) through (7), wherein determining whether to process the multimodal input with the CR data includes: training the multimodal model to: receive the multimodal input, and determine, based on the multimodal input, whether to generate a model output with the multimodal input or the multimodal input with the CR data.
(9) The method of (8), wherein the method further includes: training, by the one or more processors, the multimodal model on training data including: examples of model outputs generated with multimodal inputs, and examples of model outputs generated with the multimodal inputs and respective CR data identifying or characterizing text in each of the multimodal inputs.
(10) The method of (9), wherein determining whether to generate the CR data includes: executing the multimodal model with the multimodal input to generate a first output; executing the multimodal model with the multimodal input and the CR data to generate a second output; and outputting one of the first output and the second output based on a comparison of the first output and the second output.
(11) The method of any one of (1) through (10), further including: processing, by the one or more processors, the response through a machine learning model trained to generate output at least from the multimodal input.
(12) The method of any one of (1) through (11), wherein the CR data is optical character recognition (OCR) data generated by performing an OCR process on at least a portion of the multimodal input.
(13) A system including one or more processors and memory, the system configured to perform, by the one or more processors, operations of the method of any one of (1)-(12).
(14) One or more computer-readable storage media storing instructions that are operable, when executed by one or more processors, to cause the one or more processors to perform operations as in any one of claims (1)-(12).
(15) The one or more computer-readable storage media of (14), wherein the one or more computer-readable storage media is non-transitory.

### Example Computing Environment

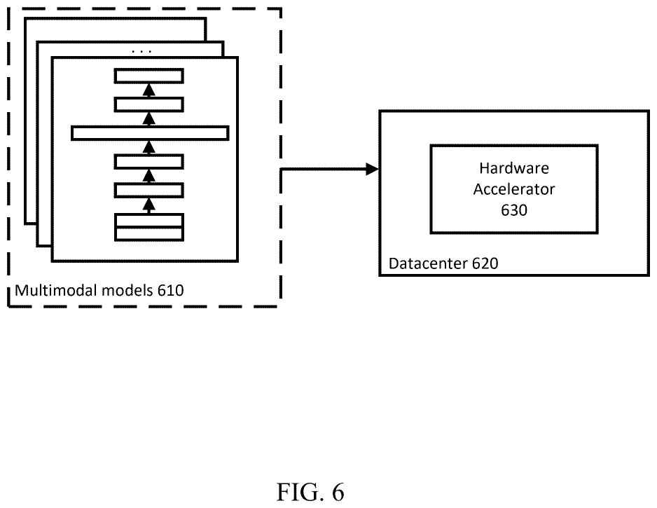

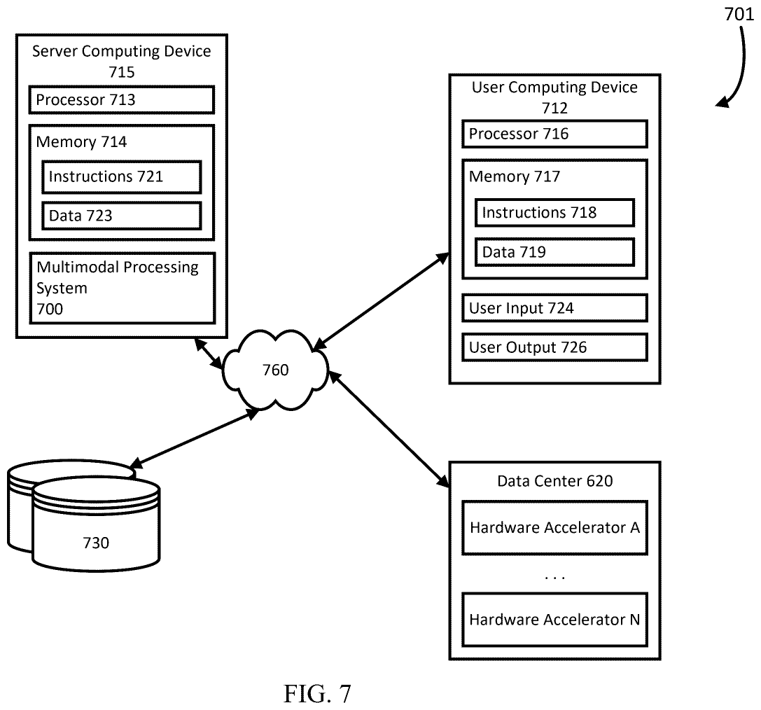

FIG. 6 is a block diagram illustrating one or more multimodal models 610, such as for deployment in a datacenter 620 housing a hardware accelerator 630 on which the deployed models will execute for multimodal processing with CR data, according to aspects of the disclosure. The hardware accelerator 630 can be any type of processor, such as a CPU, GPU, FPGA, or ASIC such as a TPU. As shown in FIG. 7, the datacenter 620 can include multiple hardware accelerators, e.g., hardware accelerators A-N.

An architecture of a model can refer to characteristics defining the model, such as characteristics of layers for the model, how the layers process input, or how the layers interact with one another. The model may be generated using machine learning or other AI training techniques. In some examples, the model may be generated through other techniques, such as an optimization technique, manual tuning from empirical data, or deterministically programmed to generate different outputs using one or more functions on received inputs. In general, a multimodal model can be of any architecture capable of receiving and processing input of different modalities, e.g., text, image, video, audio, etc.

In some examples, the multimodal models 610 may include large language models, large foundation models, large graphical models, etc. In one example, a model can be a convolutional neural network that includes a convolution layer that receives input data, followed by a pooling layer, followed by a fully connected layer that generates a result. The architecture of the model can also define types of operations performed within each layer. For example, the architecture of a convolutional neural network may define that rectified linear unit (ReLU) activation functions are used in the fully connected layer of the network.

FIG. 7 is a block diagram of an example computing environment 701 for implementing a multimodal processing system 700. The system 700 can be implemented on one or more devices having one or more processors in one or more locations, such as in server computing device 715. Examples of the system 700 include the systems 100, 200, and 300, shown and described with reference to FIGS. 1-3, respectively.

User computing device 712 and the server computing device 715 can be communicatively coupled to one or more storage devices 730 over a network 760. The storage device(s) 730 can be a combination of volatile and non-volatile memory and can be at the same or different physical locations than the computing devices 712, 715. For example, the storage device(s) 730 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 715 can include one or more processors 713 and memory 714. The memory 714 can store information accessible by the processor(s) 713, including instructions 721 that can be executed by the processor(s) 713. The memory 714 can also include data 723 that can be retrieved, manipulated, or stored by the processor(s) 713. The memory 714 can be a type of non-transitory computer readable medium capable of storing information accessible by the processor(s) 713, such as volatile and non-volatile memory. The processor(s) 713 can include one or more central processing units (CPUs), graphic processing units (GPUs), field-programmable gate arrays (FPGAs), or application-specific integrated circuits (ASICs), such as tensor processing units (TPUs).

The instructions 721 can include one or more instructions that when executed by the processor(s) 713, causes the one or more processors to perform actions defined by the instructions. The instructions 721 can be stored in object code format for direct processing by the processor(s) 713, or in other formats including interpretable scripts or collections of independent source code modules that are interpreted on demand or compiled in advance. The instructions 721 can include instructions for implementing the system 700 consistent with aspects of this disclosure. The system 700 can be executed using the processor(s) 713, or using other processors remotely located from the server computing device 715.

The data 723 can be retrieved, stored, or modified by the processor(s) 713 in accordance with the instructions 721. The data 723 can be stored in computer registers, in a relational or non-relational database as a table having a plurality of different fields and records, or as JSON, YAML, proto, or XML documents. The data 723 can also be formatted in a computer-readable format such as, but not limited to, binary values, ASCII or Unicode. Moreover, the data 723 can include information sufficient to identify relevant information, such as numbers, descriptive text, proprietary codes, pointers, references to data stored in other memories, including other network locations, or information that is used by a function to calculate relevant data.

The user computing device 712 can also be configured similarly to the server computing device 715, with one or more processors 716, memory 717, instructions 718, and data 719. The user computing device 712 can also include a user output 726, and a user input 724. The user input 724 can include any appropriate mechanism or technique for receiving input from a user, such as keyboard, mouse, mechanical actuators, soft actuators, touchscreens, microphones, and sensors.

The server computing device 715 can be configured to transmit data to the user computing device 712, and the user computing device 712 can be configured to display at least a portion of the received data on a display implemented as part of the user output 726. The user output 726 can also be used for displaying an interface between the user computing device 712 and the server computing device 715. The user output 726 can alternatively or additionally include one or more speakers, transducers or other audio outputs, a haptic interface or other tactile feedback that provides non-visual and non-audible information to the platform user of the user computing device 712.

Although FIG. 7 illustrates the processors 713, 716 and the memories 714, 717 as being within the computing devices 715, 712, components described in this specification, including the processors 713, 716 and the memories 714, 717 can include multiple processors and memories that can operate in different physical locations and not within the same computing device. For example, some of the instructions 721, 718 and the data 723, 719 can be stored on a removable SD card and others within a read-only computer chip. Some or all of the instructions and data can be stored in a location physically remote from, yet still accessible by, the processors 713, 716. Similarly, the processors 713, 716 can include a collection of processors that can perform concurrent or sequential operation. The computing devices 715, 712 can each include one or more internal clocks providing timing information, which can be used for time measurement for operations and programs run by the computing devices 715, 712.

The server computing device 715 can be configured to receive requests to process data from the user computing device 712. For example, the environment 701 can be part of a computing platform configured to provide a variety of services to users, through various user interfaces or APIs exposing the platform services. One or more services can be a machine learning framework or a set of tools for generating neural networks or other machine learning models according to a specified task and training data.

The devices 712, 715 can be capable of direct and indirect communication over the network 760. The devices 715, 712 can set up listening sockets that may accept an initiating connection for sending and receiving information. The network 760 itself can include various configurations and protocols including the Internet, World Wide Web, intranets, virtual private networks, wide area networks, local networks, and private networks using communication protocols proprietary to one or more companies. The network 760 can support a variety of short- and long-range connections. The short- and long-range connections may be made over different bandwidths, such as 2.402 GHz to 2.480 GHz (commonly associated with the Bluetooth® standard), 2.4 GHz and 5 GHZ (commonly associated with the Wi-Fi® communication protocol); or with a variety of communication standards, such as the LTE® standard for wireless broadband communication. The network 760, in addition or alternatively, can also support wired connections between the devices 712, 715, including over various types of Ethernet connection.

Although a single server computing device 715, user computing device 712, and datacenter 620 are shown in FIG. 7, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

### Example Use Cases:

As described herein, aspects of the disclosure provide for multimodal data processing. Examples of machine learning tasks follow, which may be combined or performed separately on inputs with different modalities. Example tasks include image attribution or categorization, information extraction, responding to information-seeking questions relying on texts in images, document parsing, infographic or visual aid question answering, etc.

As an example, the input to the machine learning model can be in the form of images and videos. A machine learning model can be configured to extract, identify, and generate features as part of processing a given input, for example as part of a computer vision task. A machine learning model trained to perform this type of machine learning task can be trained to generate an output classification from a set of different potential classifications. In addition, or alternatively, the machine learning model can be trained to output a score corresponding to an estimated probability that an identified subject in the image or video belongs to a certain class.

As another example, the input to the machine learning model can be data files corresponding to a particular format, e.g., HTML files, word processing documents, or formatted metadata obtained from other types of data, such as metadata for image files. A machine learning task in this context can be to classify, score, or otherwise predict some characteristic about the received input. For example, a machine learning model can be trained to predict the probability received input includes text relating to a particular subject. Also, as part of performing a particular task, the machine learning model can be trained to generate text predictions, for example as part of a tool for auto-completion of text in a document as the document is being composed. A machine learning model can also be trained to predict a translation of text in an input document to a target language, for example as a message is being composed.

Other types of input documents can be data relating to characteristics of a network of interconnected devices. These input documents can include activity logs, as well as records concerning access privileges for different computing devices to access different sources of potentially sensitive data. A machine learning model can be trained for processing these and other types of documents for predicting on-going and future security breaches to the network. For example, the machine learning model can be trained to predict intrusion into the network by a malicious actor.

As another example, the input to a machine learning model can be audio input, including streamed audio, pre-recorded audio, and audio as part of a video or other source or media. A machine learning task in the audio context can include speech recognition, including isolating speech from other identified sources of audio or enhancing characteristics of identified speech to be easier to hear. A machine learning model can be trained to predict an accurate translation of input speech to a target language, for example in real-time as part of a translation tool.

In addition to data input, including the various types of data described herein, a machine learning model can also be trained to process features corresponding to given input. Features are values, e.g., numerical or categorical, which relate to some characteristic of the input. For example, in the context of an image, a feature of the image can relate to the RGB value for each pixel in the image. A machine learning task in the image/video context can be to classify contents of an image or video, for example for the presence of different people, places, or things. Machine learning models can be trained to extract and select relevant features for processing to generate an output for a given input and can also be trained to generate new features based on learned relationships between various characteristics of input data.

Aspects of this disclosure can be implemented in digital electronic circuitry, in tangibly-embodied computer software or firmware, or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back-end component, e.g., as a data server, a middleware component, e.g., an application server, or a front-end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, by one or more processors, multimodal input comprising at least two of text, images, video, or audio;
determining, by the one or more processors and based on one or more criteria, whether to process the multimodal input with character recognition (CR) data through a multimodal model trained to receive the multimodal input and generate a multimodal model output; and
generating, by the one or more processors, the multimodal model output using the multimodal input and the CR data.

2. The method of claim 1, wherein the CR data identifies or characterizes text in the multimodal input.

3. The method of claim 1, wherein determining whether to process the multimodal input with the CR data comprises:
generating the CR data; and
determining whether the generated CR data meet the one or more predetermined criteria, and in response, generating, by the one or more processors, the multimodal model output using the multimodal input without the CR data.

4. The method of claim 1, wherein determining whether to process the multimodal input with CR data comprises determining whether the multimodal input or the CR data satisfy the one or more predetermined criteria, comprising one or more of whether:
the CR data was received past a predetermined latency period,
the multimodal input or the CR data includes a quantity of images in excess of a predetermined limit,
a confidence rating in generating the CR data is below a predetermined threshold,
the quality of components of the multimodal input or the CR data does not meet a predetermined threshold,
the size of images or video of the multimodal input exceeds a predetermined maximum size,
the multimodal input with the CR data includes a quantity of symbols, words, lines, or paragraphs below a predetermined threshold determined for the multimodal model to perform a task it was trained to perform, or
the multimodal input and the CR data exceeds a predetermined maximum input size.

5. The method of claim 1, wherein determining whether to process the multimodal input with the CR data comprises:
determining, based on the multimodal input and the one or more criteria, whether to generate the CR data from the multimodal input; and
generating the CR data from the multimodal input.

6. The method of claim 5, wherein the one or more criteria are based on at least one of:
the length of the multimodal input,
the quantity of images or videos in the multimodal input,
the size of the images or video in the multimodal input, or
the resolution or quality of components of the multimodal input.

7. The method of claim 1, wherein the method further comprises:
generating, by the one or more processors, the CR data; and
formatting, by the one or more processors, the multimodal input and the CR data according to one of one or more predetermined formats.

8. The method of claim 1, wherein determining whether to process the multimodal input with the CR data comprises:
training the multimodal model to:
receive the multimodal input, and
determine, based on the multimodal input, whether to generate a model output with the multimodal input or the multimodal input with the CR data.

9. The method of claim 8, wherein the method further comprises:
training, by the one or more processors, the multimodal model on training data comprising:
examples of model outputs generated with multimodal inputs, and
examples of model outputs generated with the multimodal inputs and respective CR data identifying or characterizing text in each of the multimodal inputs.

10. The method of claim 9, wherein determining whether to generate the CR data comprises:
executing the multimodal model with the multimodal input to generate a first output;
executing the multimodal model with the multimodal input and the CR data to generate a second output; and
outputting one of the first output and the second output based on a comparison of the first output and the second output.

11. The method of claim 1, further comprising:
processing, by the one or more processors, the response through a machine learning model trained to generate output at least from the multimodal input.

12. The method of claim 1, wherein the CR data is optical character recognition (OCR) data generated by performing an OCR process on at least a portion of the multimodal input.

13. A system, comprising:
one or more processors configured to:
receive multimodal input comprising at least two of text, images, video, or audio;
determine, based on one or criteria, whether to process the multimodal input with character recognition (CR) data through a multimodal model trained to receive the multimodal input and generate a multimodal model output; and
generate, by the one or more processors, the multimodal model output using the multimodal input and the CR data.

14. The system of claim 13, wherein in determining whether to process the multimodal input with the CR data, the one or more processors are configured to:
generate the CR data; and
determine whether the generated CR data meet the one or more predetermined criteria, and generate, by the one or more processors, the multimodal model output using the multimodal input without the CR data.

15. The system of claim 14, wherein in determining whether to process the multimodal input with the CR data comprises, the one or more processors are configured to train the model to:
receive the multimodal input, and
determine, based on the multimodal input, whether to generate a model output with the multimodal input or the multimodal input with the CR data.

16. The system of claim 13, wherein determining whether to process the multimodal input with CR data comprises determining whether the multimodal input or the CR data satisfy the one or more predetermined criteria, comprising one or more of whether:
the CR data was received past a predetermined latency period,
the multimodal input or the CR data includes a quantity of images in excess of a predetermined limit,
a confidence rating in generating the CR data is below a predetermined threshold,
the quality of components of the multimodal input or the CR data does not meet a predetermined threshold,
the size of images or video of the multimodal input exceeds a predetermined maximum size,
the multimodal input with the CR data includes a quantity of symbols, words, lines, or paragraphs below a predetermined threshold determined for the multimodal model to perform a task it was trained to perform, or
the multimodal input and the CR data exceeds a predetermined maximum input size.

17. The system of claim 16, wherein determining whether to process the multimodal input with the CR data comprises:
determining, based on the multimodal input and the one or more criteria, whether to generate the CR data from the multimodal input; and
generating the CR data from the multimodal input.

18. The system of claim 17, wherein the one or more criteria are based on at least one of:
the length of the multimodal input,
the quantity of images or videos in the multimodal input,
the size of the images or video in the multimodal input, or
the resolution or quality of components of the multimodal input.

19. The system of claim 13, wherein the CR data is optical character recognition (OCR) data generated by performing an OCR process on at least a portion of the multimodal input.

20. One or more non-transitory computer-readable storage media storing instructions that are operable, when executed by one or more processors, to perform operations comprising:
receiving multimodal input comprising at least two of text, images, video, or audio;
determining, based on one or more predetermined criteria, whether to process the multimodal input with character recognition (CR) data through a multimodal model trained to receive the multimodal input and generate a model output; and
generating the multimodal model output using the multimodal input and the CR data.
